(19) United States
(12) Patent Application Publication
(10) Pub. No.: US 2017/0170457 A1
(43) Pub. Date: Jun. 15, 2017

(54) POWDER SINTERING SYSTEM

(71) Applicants: JIANGSU HUADONG INSTITUTE OF LI-ION BATTERY CO., LTD., Suzhou (CN); TSINGHUA UNIVERSITY, Beijing (CN)

(72) Inventors: Xiang-Ming He, Beijing (CN); Jian-Jun Li, Beijing (CN); Jian-Li Zhang, Beijing (CN); Li Wang, Beijing (CN); Yu-Ming Shang, Beijing (CN); Cheng-Hao Xu, Beijing (CN); Jing Luo, Beijing (CN); Jian Gao, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/443,304

(22) Filed: Feb. 27, 2017

Related U.S. Application Data
(63) Continuation of application No. PCT/CN2014/091942, filed on Nov. 21, 2014.

(30) Foreign Application Priority Data
Aug. 29, 2014 (CN) 201410434097.7

(51) Int. Cl. H01M 4/1391; H01M 4/131

(52) U.S. Cl. CPC H01M 4/1391; H01M 4/131

(57) ABSTRACT

A powder sintering system is disclosed. The powder sintering system includes a furnace body, a first dispersing device, a second dispersing device, and a heating device. The furnace body includes a bottom and a side wall defines a funnel shaped chamber. The at least one first dispersing device is located on the bottom, and configured to centrifugally disperse and throw powder from the bottom to the side wall. The at least one second dispersing device is located on the side wall, and configured to centrifugally disperse and throw the powder from the side wall to a center of the funnel shaped chamber. The heating device is located outside the furnace body.

### CROSS-REFERENCE TO RELATED APPLICATIONS

This application claims all benefits accruing under 35 U.S.C. §119 from China Patent Application No. 201410434097.7, filed on Aug. 29, 2014 in the State Intellectual Property Office of China, the content of which is hereby incorporated by reference. This application is a continuation under 35 U.S.C. §120 of international patent application PCT/CN2014/091942, filed on Nov. 21, 2014, the content of which is also hereby incorporated by reference.

### FIELD

The present disclosure relates to powder sintering systems and, particularly, to a powder sintering system under an atmospheric protection condition.

### BACKGROUND

Powder usually refers to a collection of discrete, small solid particles. Airborne powder can cause great harm to those exposed to the airborne powder over a long term. Sintering can fuse the collection of discrete particles into a material or product of crystalline combination, to make effective use of the powder, and reduce environmental pollution.

Powder sintering systems generally involve a static sintering process. In the static sintering process, because the powder is stacked, the sintering temperature difference inside the stacked powder and outside of the stacked powder can be significant. The unevenly mixed powder could result in powder not fully sintered. Thus, the product yield of the powder sintering is relatively low.

### BRIEF DESCRIPTION OF THE DRAWINGS

Implementations are described by way of example only with reference to the attached figures.

FIG. 1 is a cross-sectional view of one embodiment of a powder sintering system.

FIG. 2 is a schematic structural view of a first dispersing device of one embodiment of the powder sintering system.

FIG. 3 is a top view of the first dispersing device in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

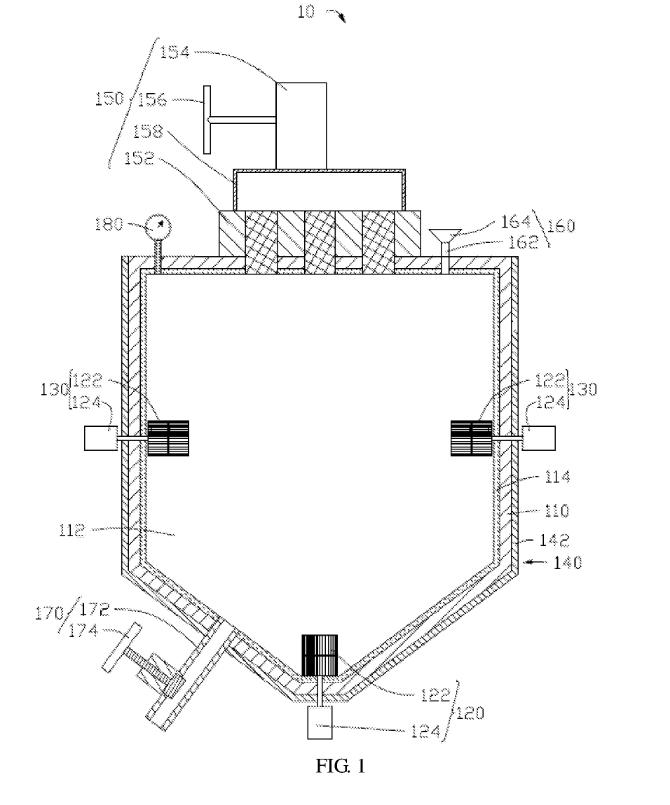

Referring to FIG. 1, one embodiment of a powder sintering system 10 is disclosed. The powder sintering system 10 includes a furnace body 110, a first dispersing device 120, a second dispersing device 130, a heating device 140, an exhaust device 150, a feed device 160, and a discharge device 170.

The furnace body 110 defines a funnel shaped chamber 112 with a closed structure. An upper portion of the furnace body 110 can be a hollow column shaped structure, a hollow cone shaped structure, or a hollow frustum shaped structure, etc. A lower portion of the furnace body 110 can be a hollow frustum shaped structure. In one embodiment, the upper portion of the furnace body 110 has a hollow column shaped structure, and the lower portion of the furnace body 110 has a hollow frustum shaped structure. The hollow column shaped structure and the hollow frustum shaped structure are connected together to form the funnel shaped chamber 112. The hollow column shaped structure can be a hollow cylinder or a hollow prism. The hollow prism can be a hollow quadrangular prism, a hollow pentagonal prism, or a hollow hexagonal prism. The hollow frustum structure can be a hollow conical frustum or a hollow pyramidal frustum, which cooperates with the hollow cylinder or hollow prism. When the hollow prism is a hollow quadrangular prism, a hollow pentagonal prism or a hollow hexagonal prism, the hollow pyramidal frustum can also be quadrangular, pentagonal or hexagonal respectively, to match the shape of the hollow prism.

In one embodiment, the upper portion of the furnace body 110 can be a hollow cylinder, and the lower portion of the furnace body 110 can be a hollow conical frustum. A material of the furnace body 110 can be selected from heat resistance materials. A surface coating layer 114 can be coated on an inner wall of the furnace body 110 to prevent powder from adhering to the inner wall of the furnace body 110 during sintering. The surface coating layer 114 can be a ceramic-based coating, a graphite-based coating, a polytetrafluoroethylene coating, or other high temperature resistant coatings. The surface coating layer 114 can prevent the introduction of metallic impurities such as iron and make the production process cleaner.

The first dispersing device 120 can be configured to centrifugally disperse the powder at the bottom of the furnace body 110 to the side wall of the furnace body 110, thereby improving the mixing of the powder uniformly. That is, the powder is propelled by the spinning of the first dispensing device 120. The number of the first dispersing devices 120 can be one or more according to actual needs. The first dispersing device 120 is located at the bottom of the furnace body 110. In some embodiments, a single first dispersing device 120 is located at a center of the bottom of the furnace body 110. In one embodiment, one first dispersing device 120 is disposed at the center of the bottom surface of the hollow frustum structure.

The second dispersing device 130 can be configured to centrifugally disperse powder at the side wall of the furnace body 110 to the funnel shaped chamber 112. That is, the powder is propelled by the spinning of the second dispensing device 130. In one embodiment, the second dispersing device 130 can disperse the powder from the side wall of the furnace body 110 to a central axis position of the funnel shaped chamber 112. The number of the second dispersing devices 130 can be one or more according to actual needs. The second dispersing device 130 can be located on the side wall of the furnace body 110. In one embodiment, the second dispersing device 130 can be located on the side wall of the furnace body 110 and close to a top of the furnace body 110.

When the number of the second dispersing devices 130 is two or more, the second dispersing devices 130 can be located at the same height or at different heights on the side wall of the furnace body 110. The second dispersing devices 130 can be located opposite each other, opposite each other and offset a certain distance, or provided anywhere along the side wall of the furnace body 100. In one embodiment, the second dispersing devices 130 can be disposed at the same height on the side wall of the furnace body 110. In another embodiment, the second dispersing devices 130 are at the same height on the side wall of the furnace body 110. In yet another embodiment, the second dispersing devices 130 are at the same height opposite to each other as one or more pairs with respect to the central axis of the furnace body 110. The location of the dispersing devices 120, 130 of the powder sintering system 10 can be arranged to be more conducive to adjust and accommodate the movement trajectory of the powder in the furnace body 110. When the second dispersing devices 130 are located at different heights on the sidewall of the furnace body 110, the distribution of the powder can be controlled by adjusting the rotational speed of the two or more second dispersing devices 130 individually. In one embodiment, two second dispersing devices 130 can be disposed at the same height on the side wall of the hollow cylinder, and arranged opposite to each other with respect to the central axis of the funnel shaped chamber 112.

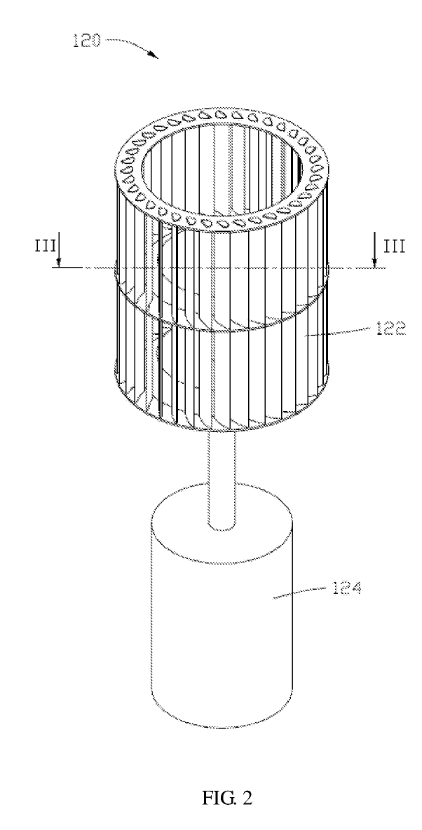

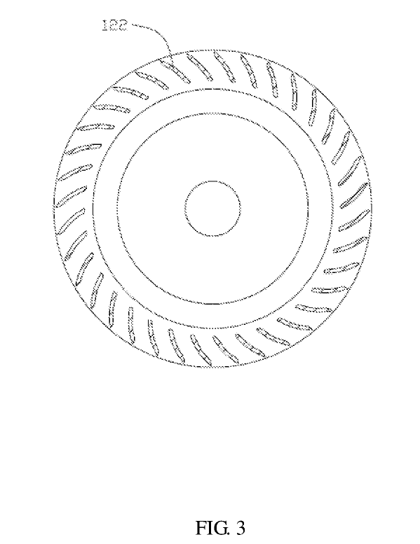

Referring to FIGS. 2 and 3, the first dispersing device 120 includes a dispersing wheel 122, an actuator 124, and a circuit controller (not shown). The dispersing wheel 122 is located inside the furnace body 110 and used for centrifugally dispersing the powder in the furnace body 110. A material of the dispersing wheel 122 can be a high temperature resistant material such as a ceramic or a stainless steel alloy. A rotational speed of the dispersing wheel 122 can be in a range from about 0 to about 20000 r/min. In one embodiment, the rotational speed of the dispersing wheel 122 can be in a range from about 2000 to about 10000 r/min. The speed range is not only conducive to effectively centrifugally disperse the powder to mix the powder uniformly, but also conducive to improve stability of the powder sintering system 10, and reduce energy consumption.

The actuator 124 is located outside the furnace body 110 for driving the dispersing wheel 122 to rotate at a constant rotational speed. The actuator 124 can be a magnetically coupled actuator, a motor control actuator, or a mechanical actuator. The circuit controller is connected to the actuator 124 and provides power to the actuator 124. In one embodiment, a rotation axis of the dispersing wheel 122 of the first dispersing device 120 is parallel to a center axis of the funnel shaped chamber 112. The dispersing wheel 122 is a hollow cage type agitator. When the dispersing wheel 122 rotates with a high speed, a negative pressure is generated at the center of the dispersing wheel 122, and the powder can be moved away around the dispersing wheel 122.

The dispersing wheel 122 can comprise a plurality of fins sandwiched between two rings and arranged around an axis of the dispersing wheel 122. The fins can be straight, curved, or specially shaped to engage the powder by striking the powder and propelling the powder away from the dispersing wheel 122. The fins can have a thin profile and be angled radially, tangentially, or both radially and tangentially relative to the axis of the dispersing wheel 122. As shown in FIG. 2, the fins are curved and spaced equidistantly around the axis of the dispersing wheel. The fins and rings of the dispersing wheel 122 may also be stacked on top of another to form a longer dispersing wheel 122 so that thinner profile fins can be used, as shown in FIG. 3.

A structure, material, and rotational speed of the second dispersing device 130 can be the same as a structure, material, and rotational speed of the first dispersing device 120 as described above, respectively, except that a rotation axis of the dispersing wheel 122 of the second dispersing device 130 is perpendicular or at an angle to the central axis of the funnel shaped chamber 112.

The heating device 140 includes a heating element 142 and a thermocouple (not shown). The heating element 142 is located outside the furnace body 110 for heating the furnace body 110. The heating device 140 can heat the furnace body 110 to raise the temperature of the funnel shaped chamber 112 within a range from about 100° C. to about 1300° C. . In one embodiment, the heating element 142 of the heating device 140 is a resistance wire wound around an outer surface of the furnace body 110. The thermocouple is located inside the funnel shaped chamber 112 for detecting the temperature of the funnel shaped chamber 112.

In one embodiment, the heating device 140 can further include a protecting layer (not shown) and a thermal insulating layer (not shown). The thermal insulating layer and the protecting layer can be sequent coated on an outer surface of the heating element 142.

The exhaust device 150 is configured to promptly discharge sintered products such as hot smoke and gas in the sintering process. The exhaust device 150 can include a gas-solid separating unit 152, an exhaust pipe 154, an automatic control valve 156, and a gas buffer unit 158. The gas-solid separating unit 152 is located on the top of the furnace body 110 for preventing clogging of the exhaust pipe 154. The gas-solid separating unit 152 can include heat resistance elements such as a gas-solid separator, a filter screen, and a pulsed reverse-inflating element. The gas buffer unit 158 is located on one end of the gas-solid separating unit 152, and the end is away from the furnace body 110. The exhaust pipe 154 is located on one end of the gas buffer unit 158, and the end is away from the furnace body 110. The automatic control valve 156 is disposed on the exhaust pipe 154. The automatic control valve 156 can automatically open the exhaust pipe 154 when the pressure inside the funnel shaped chamber 112 exceeds a set value.

The feed device 160 can be located on the top of the furnace body 110, and capable of feeding powder into a chamber of the furnace body. In one embodiment, the feed device 160 is positioned so that the powder can drop to the bottom of the furnace body 110 by its own weight. The feed device 160 can include a feed pipe 162, a tapered container 164, and a butterfly valve (not shown). The butterfly valve is located between the feed pipe 162 and the tapered container 164. The tapered container 164 is connected to the funnel shaped chamber 112 through the feed pipe 162. The powder can be temporarily stored in the tapered container 164. During the feeding, the powder is transferred from the tapered container 164 into the feed pipe 162 through the butterfly valve, and fed gradually into the funnel shaped chamber 112 through the feed pipe 162.

The discharge device 170 is located on a lower portion of the side wall of the furnace body 110 for discharging the sintered powder from the funnel shaped chamber 112. The discharge device 170 can include a discharge pipe 172 and a control valve 174. The control valve 174 is located on the discharge pipe 172. When the powder is to be discharged after the sintering of the powder is completed, the control valve 174 is opened to discharge the sintered powder out the funnel shaped chamber 112 under the force of gravity, a supply gas, vacuum, or a combination of forces. It is to be understood that the number of feed devices 160 and the discharge device 170 each can be two or more.

The powder sintering system 10 can further include a pressure sensing device 180. The pressure sensing device 180 is used for detecting the gas pressure in the funnel shaped chamber 112. The pressure sensing device 180 can be located on top of the furnace body 110.

The powder sintering system 10 can further include a viewing window (not shown) to facilitate viewing of the state of the powder in the funnel shaped chamber 112. The viewing window can be located on the sidewall or the top of the furnace body 110.

The powder sintering system 10 can be used for preparing a cathode active material or an anode active material of a lithium ion battery, which are mainly lithium transition metal composite oxides, such as lithium iron phosphate, lithium cobalt oxide, lithium manganese oxide, lithium nickel oxide, and lithium titanate.

A work principle of the powder sintering system 10 is explained as follows. Powder is temporarily stored in the tapered container 164. When feed of the powder is needed, the powder is transferred into the feed pipe 164 and is gradually fed into the funnel shaped chamber 112 via the feed pipe 164. When the powder reaches the first dispersing device 120 located on the bottom of the furnace body, the powder is dispersed away from the spinning of the first dispensing device 120 by the first dispensing device 120, and propelled to the side wall of the furnace body 110, with the powder spirally raised along the side wall of the furnace body 110. The powder on the side wall of the furnace body 110 is sintered via heating by the heating device 140. If the powder is reaches the second dispersing device 130, the powder is again moved away by the spinning second dispersing device 130 and thrown towards the center of the funnel shaped chamber 112. The tossed powder returns to the first dispensing device 120 falling under the action of its own weight or directly from the second dispersing device 130 and is again propelled and dispersed by the first dispensing device 120, thus forming a cycling process. Therefore, the first dispersing device 120 and the second dispersing device 130 work together to evenly mix the powder and sinter the powder.

The powder sintering system provided in the present disclosure has the following characteristics. First, the dynamic sintering of the powder inside the furnace body can be realized by rationally arranging the dispersing device so that the powder can be uniformly dispersed in the sintering process. Second, in the powder sintering process, only the intake pipe and the feed pipe communicate with the outside environment, which makes the powder sintering system sealed well. Third, the surface coating layer located on the inner wall of the furnace body can avoid the introducing of impurities such as iron during sintering, which make the producing process more clear. In addition, the powder sintering system also has a small occupying space.

Other embodiments of the disclosure will be apparent to those skilled in the art from consideration of the specification and practice of the embodiments disclosed herein. It is intended that the specification and examples be considered as exemplary only, with the true scope and spirit of the embodiments being indicated by the following claims.

What is claimed is:

1. A powder sintering system, comprising:
a furnace body comprising a bottom and a side wall defining a funnel shaped chamber;
at least one first dispersing device located on the bottom of the furnace body, the at least one first dispersing device configured to centrifugally disperse powder from the bottom of the furnace body to the side wall of the furnace body;
at least one second dispersing device located on the side wall of the furnace body, the at least one second dispersing device configured to centrifugally disperse powder from the side wall of the furnace body to a center of the funnel shaped chamber;
a heating device located outside the furnace body.

2. The powder sintering system of claim 1, wherein an upper portion of the furnace body has a hollow column shaped structure, a lower portion of the furnace body has a hollow frustum shaped structure, and the hollow column shaped structure and the hollow frustum shaped structure are connected together to form the furnace body.

3. The powder sintering system of claim 1, further comprising a surface coating layer is coated on an inner wall of the furnace body, wherein the surface coating layer is a ceramic-based coating layer, a graphite-based coating layer, or a polytetrafluoroethylene coating layer.

4. The powder sintering system of claim 1, wherein the at least one first dispersing device is located at a center of the bottom of the furnace body.

5. The powder sintering system of claim 1, wherein the at least one second dispersing device is adjacent to a top of the furnace body.

6. The powder sintering system of claim 1, wherein the at least one second dispersing device is a plurality of second dispersing devices located at a same height on the side wall of the furnace body relative to the bottom of the furnace body.

7. The powder sintering system of claim 6, wherein the plurality of second dispersing devices form one or more pairs of second dispersing devices, each pair of second dispersing devices having two opposing second dispersing devices opposite to each other with respect to a central axis of the furnace body.

8. The powder sintering system of claim 1, wherein each of the at least one first dispersing device and the at least one second dispersing device comprises a dispersing wheel and an actuator, the dispersing wheel is located inside the furnace body, and the actuator is located outside the furnace body for driving the dispersing wheel.

9. The powder sintering system of claim 1, further comprising an exhaust device configured to discharge smoke or gas produced in the funnel shaped chamber in a sintering process, the exhaust device comprising a gas-solid separating unit, an automatic control valve, a gas buffer unit, and an exhaust pipe, wherein the gas-solid separating unit is located on a top of the furnace body, the gas buffer unit is located on an end of the gas-solid separating unit away from the furnace body, the exhaust pipe extend from an end of the gas buffer unit, and the automatic control valve is located on the exhaust pipe.

10. The powder sintering system of claim 1, further comprising a feed pipe, and a tapered container, wherein the tapered container is connected to the funnel shaped chamber through the feed pipe.

11. A powder sintering system, comprising:
a furnace body comprising a bottom and a side wall defining a funnel shaped chamber with a closed structure;
at least one first dispersing device located on the bottom of the furnace body, the at least one first dispersing device configured to centrifugally disperse powder from the bottom of the furnace body to the side wall of the furnace body;
a plurality of second dispersing devices located on the side wall, the second dispersing devices each configured to centrifugally disperse powder from the side wall of the furnace body to a center of the funnel shaped chamber;
a heating device located on outer surface of the outside the furnace body;
an exhaust device configured to discharge flue smoke produced in the funnel shaped chamber in sintering process;
a feed device located on top of the furnace body; and
a discharge device located on a lower portion of the side wall of the furnace body to discharge the sintered powder from the funnel shaped chamber.

12. The powder sintering system of claim 11, wherein an upper portion of the furnace body has a hollow column shaped structure, a lower portion of the furnace body has a hollow frustum shaped structure, and the hollow column shaped structure and the hollow frustum shaped structure are connected together to form the funnel shaped chamber.

13. The powder sintering system of claim 11, further comprising a surface coating layer coated on an inner wall of the furnace body, wherein the surface coating layer is a ceramic-based coating layer, a graphite-based coating layer, or a polytetrafluoroethylene coating layer.

14. The powder sintering system of claim 11, wherein the at least one dispersing device is located at a center of the bottom of the furnace body.

15. The powder sintering system of claim 11, wherein the plurality of dispersing devices are adjacent to the top of the furnace body.

16. The powder sintering system of claim 1, wherein the plurality of dispersing devices are located at a same height on the side wall of the furnace body.

17. The powder sintering system of claim 16, wherein the plurality of second dispersing devices form one or more pairs of second dispersing devices, each pair of the second dispersing devices having two opposing second dispensing devices opposite to each other with respect to a central axis of the furnace body.

18. The powder sintering system of claim 11, wherein each of the at least one first dispersing device and the at least two second dispersing devices comprises a dispersing wheel and an actuator, the dispersing wheel is located inside the furnace body, the actuator is located outside the furnace body for driving the dispersing wheel.

19. The powder sintering system of claim 11, wherein the exhaust device comprises a gas-solid separating unit, an automatic control valve, a gas buffer unit and an exhaust pipe, the gas-solid separating unit is located on the top of the furnace body, the gas buffer unit is located on one end of the gas-solid separating unit away from the furnace body, the exhaust pipe extends from an end of the gas buffer unit, and the automatic control valve is located on the exhaust pipe.

20. The powder sintering system of claim 11, wherein the feed device comprises a feed pipe, and a tapered container the tapered container is connected to the funnel shaped chamber through the feed pipe.
